(19) United States
(12) Patent Application Publication
(10) Pub. No.: US 2026/0284662 A1
(43) Pub. Date: Sep. 24, 2026

(54) SYSTEM AND METHOD FOR OCTAHEDRAL MICROFLUIDIC MANIPULATION

(71) Applicant: The Regents of the University of California, Oakland, CA (US)

(72) Inventor: Bin Liu, Merced, CA (US)

(21) Appl. No.: 19/561,740

(22) Filed: Mar. 10, 2026

Related U.S. Application Data
(60) Provisional application No. 63/774,415, filed on Mar. 19, 2025.

(51) Int. Cl. B01L 3/00

(52) U.S. Cl. CPC B01L 3/502746; B01L 3/502715; B01L 2200/0647; B01L 2300/0654; B01L 2400/082

(57) ABSTRACT

A microfluidic manipulation system includes a microfluidic chip having a central cylindrical chamber and a plurality of microfluidic channels arranged around the central cylindrical chamber at positions corresponding to vertices of an octahedron. Fluidic ports in fluid communication with the microfluidic channels are configured to independently introduce or withdraw fluid. An imaging system captures images of one or more particles within the central cylindrical chamber from at least two distinct focal planes. A computing device analyzes the captured images to determine particle positions relative to target positions and generates channel-specific control signals to independently regulate fluid flow through the microfluidic channels. The regulated flows generate substantially uniform flow fields for controlled, stress-reduced manipulation of microscale objects. In certain embodiments, time-varying control signals with defined phase relationships generate oscillating quadrupole flow structures or controllable vortex flow patterns within the central cylindrical chamber.

### CROSS-REFERENCE TO RELATED APPLICATIONS

This application claims the benefit of, and priority to, U.S. Provisional Patent Application No. 63/774,415 filed on Mar. 19, 2025. The entire contents of the foregoing application are incorporated by reference herein.

### GOVERNMENT LICENSE RIGHTS

This invention was made with Government support under Grant No. CBET-2046822, awarded by the National Science Foundation. The Government has certain rights in the invention.

### BACKGROUND

Micromanipulation of microscopic objects has become a key component in diverse fields involving cellular biology, materials science, and micromechanical systems. In many existing methods, external forces or confinement techniques are employed to control particles in liquid media, including optical or acoustic tweezers, magnetic fields, or flow-based traps. While these methods can facilitate precise particle handling, each approach often introduces stress or unwanted perturbations to the particles or cells under examination.

Previous attempts to mitigate these effects have included refining optical trapping configurations to decrease localized heat and force gradients, as well as developing specialized microfluidic designs to produce more uniform flows. However, truly uniform flow structures in three dimensions remain difficult to achieve. In many cases, flow fields are only locally uniform or require feedback mechanisms that can complicate implementation, thereby limiting throughput and reproducibility.

Accordingly, there is a need for an approach that enables robust, three-dimensional manipulation of microscale particles without introducing the types of stress typically encountered in trap-based systems. Such an approach would preserve the natural state of delicate particles or cells, offering both long-term viability and accurate measurement conditions, while still affording the necessary spatial control for complex manipulations within a microfluidic setting.

### SUMMARY

According to one embodiment of the present disclosure, a microfluidic manipulation system is provided. The system includes a microfluidic chip having a central cylindrical chamber and a plurality of microfluidic channels arranged around the central cylindrical chamber at positions corresponding to vertices of an octahedron. A plurality of fluidic ports in fluid communication with the microfluidic channels may be configured to independently introduce or withdraw fluid from the central cylindrical chamber. An imaging system may be configured to capture images of a microscale object (e.g., particle or microorganism) within the central cylindrical chamber from at least two distinct focal planes. A computing device may be operatively coupled to the imaging system and configured to analyze captured images, determine particle positions relative to target positions, and generate control signals for independently regulating fluid flow through the microfluidic channels to achieve controlled, substantially stress-free manipulation of particles or microorganisms.

In certain embodiments, the plurality of microfluidic channels may include six channels arranged in pairs at two distinct vertical levels around the central cylindrical chamber. The imaging system may include multiple cameras positioned to simultaneously image particles at different focal planes for three-dimensional position tracking. The computing device may independently regulate the microfluidic channels to generate substantially uniform flow fields along selected orthogonal directions within the central cylindrical chamber and may generate three-dimensional flow vectors by additive combination of flow contributions from the plurality of microfluidic channels.

In some implementations, time-varying control signals may be applied to the fluidic ports such that pressures applied to the plurality of microfluidic channels vary as functions of time with defined phase relationships. Such time-dependent control may be used to generate oscillating quadrupole flow structures or controllable vortex flow patterns within the central cylindrical chamber.

According to another embodiment of the present disclosure, a method of manipulating a microscale object within a microfluidic system is provided. The method includes capturing images of the microscale object from at least two distinct focal planes, determining a three-dimensional position of the microscale object relative to a target position, and regulating fluid flow through microfluidic channels by generating channel-specific control signals. In certain embodiments, motion of the microscale object may be decomposed into components having different temporal characteristics, with a multi-axis stage compensating a first motion component and fluid flow regulation compensating a second motion component. Stage control and fluid flow regulation may be iteratively updated in a closed-loop feedback process to maintain the microscale object at a target position or along a predefined three-dimensional trajectory.

### BRIEF DESCRIPTION OF DRAWINGS

Various embodiments of the present disclosure are described hereinbelow with reference to the figures wherein:

FIG. 1 is a perspective view, with parts separated, of an octahedral microfluidic system with an inset showing a chamber according to an embodiment of the present disclosure;

FIG. 2 shows schematic diagrams illustrating uniform flow fields along three orthogonal directions, each exhibiting octahedral symmetry, according to an embodiment of the present disclosure;

FIG. 3 is a schematic diagram illustrating octahedral flows implemented in the octahedral microfluidic system of FIG. 1, according to an embodiment of the present disclosure;

FIG. 4 is a schematic diagram illustrating an imaging system suitable for use with the octahedral microfluidic system of FIG. 1, according to an embodiment of the present disclosure;

FIG. 5 shows two example screenshots captured by the pair of tracking cameras in the imaging system of FIG. 4;

FIG. 6 is a schematic diagram illustrating a computing algorithm implemented in a computing device controlling the octahedral microfluidic system of FIG. 1, according to an embodiment of the present disclosure;

FIG. 7 is a three dimensional trace of a particle traveling within the octahedral microfluidic system according to an embodiment of the present disclosure;

FIG. 8 is a perspective view, with parts separated, of an octahedral microfluidic system integrated with a three-axis stage and a microscope objective lens according to an embodiment of the present disclosure;

FIG. 9 is a schematic diagram illustrating a feedback-control architecture of the octahedral microfluidic system in which image-based position acquisition is used to generate coordinated flow velocity control and stage position control according to an embodiment of the present disclosure;

FIGS. 10A-10C illustrate exemplary steady-state flow modes generated within the central cylindrical chamber by selectively actuating the plurality of microfluidic channels according to embodiments of the present disclosure;

FIG. 11 illustrates an oscillatory pressure-control mode in which time-varying pressures are applied to the plurality of microfluidic channels with controlled phase relationships according to an embodiment of the present disclosure;

FIG. 12 is a schematic representation of a time-dependent flow field generated within the central cylindrical chamber using oscillatory pressure actuation of the microfluidic channels according to an embodiment of the present disclosure;

FIG. 13 is a schematic diagram of a rotation-based pressure controller configured to generate time-dependent pressure signals for the plurality of microfluidic channels according to an embodiment of the present disclosure;

FIG. 14 is a photograph of an example physical implementation of the rotation-based pressure controller of FIG. 13, illustrating a motor-driven rotating kernel assembly coupled to compressed air and vacuum sources and to multiple pressure tubes according to an embodiment of the present disclosure; and

FIG. 15 is a flow diagram illustrating a method of manipulating a microscale object within the central cylindrical chamber of the microfluidic chip using coordinated image-based position acquisition, stage control, and independent regulation of fluid flow through the plurality of microfluidic channels according to an embodiment of the present disclosure.

### DETAILED DESCRIPTION

The present disclosure relates to octahedral microfluidic systems configured to produce uniform flow fields along three orthogonal directions. By arranging a series of independently controllable channels around a central chamber in an octahedral configuration, the system enables precise, stress-free manipulations of microscale particles. The architecture leverages symmetrical flow modes to achieve uniform fields that can be combined or switched in real time, allowing particles to be moved freely in three-dimensional space without introducing significant shear forces. The system may further include an imaging assembly and computing algorithms for automated or real-time feedback control, making it suitable for diverse applications that benefit from minimally perturbative manipulations of sensitive cells or other microscopic objects.

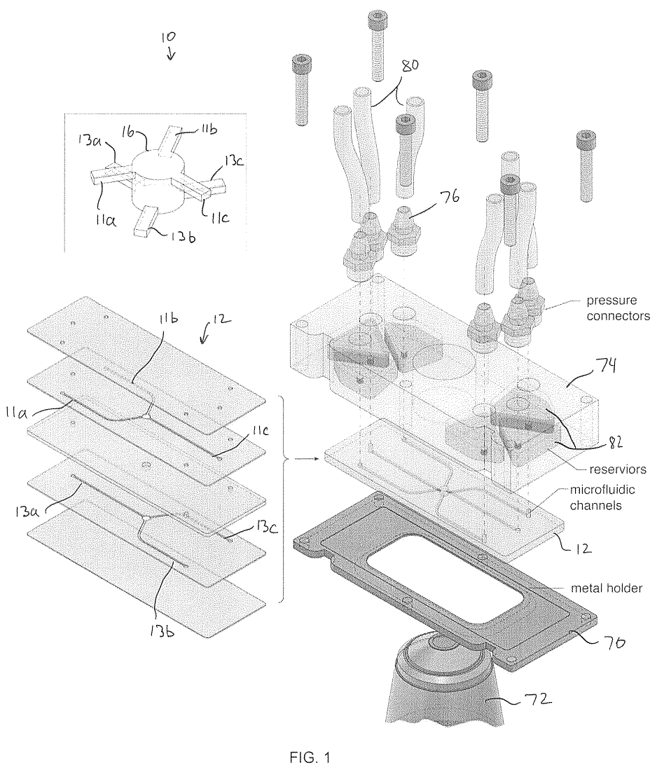

With reference to FIG. 1, an octahedral microfluidic system 10 includes a microfluidic chip 12 configured for generating stress-free flow fields suitable for micromanipulation applications. The microfluidic chip 12 may be formed from multiple optically clear sheets 14 layered and fused together using optically clear adhesives (OCA) to form a compact, integrated assembly. The microfluidic chip 12 defines a central cylindrical chamber 16, which functions as an interaction zone for microscale particles. Six microfluidic channels (11a, 11b, 11c, 13a, 13b, and 13c) intersect this central cylindrical chamber 16 (see inset of FIG. 1) at positions corresponding to vertices of an octahedron, arranged at two distinct vertical levels. This arrangement facilitates precise and stress-free particle manipulation through uniform flow fields generated in three-dimensional space.

Although the illustrated embodiment depicts the microfluidic chip 12 as being formed from multiple optically clear sheets 14 that are stacked and bonded together, the microfluidic chip 12 is not limited to a multilayer laminated construction. In other embodiments, the microfluidic chip 12 may be fabricated as a monolithic structure. For example, the central cylindrical chamber 16 and the microfluidic channels 11a-13c may be formed using additive manufacturing techniques, including three-dimensional printing processes capable of producing optically transparent or optically translucent structures. Suitable fabrication approaches may include stereolithography, digital light processing, two-photon polymerization, injection molding, micromachining, or other microfabrication techniques capable of forming internal fluidic geometries with sufficient optical clarity for imaging through the central cylindrical chamber 16.

In such embodiments, the microfluidic chip 12 may be fabricated from a transparent polymeric material, glass, resin, or other optically compatible material that permits imaging of microscale objects within the central cylindrical chamber 16 using the imaging system 20. The functional arrangement of the microfluidic channels at positions corresponding to vertices of an octahedron relative to the central cylindrical chamber 16 may be preserved regardless of the specific fabrication technique employed. Accordingly, the structural and functional principles described herein are not dependent upon a laminated sheet architecture and may be implemented using any manufacturing process capable of producing the disclosed three-dimensional channel configuration.

The microfluidic chip 12 may have a size of a conventional glass slide, making it fully compatible with traditional microscopes. This allows the microfluidic chip 12 to fit seamlessly into conventional microscope setups, utilizing standard microscope adapters and mounts for easy integration with bright-field, phase contrast, or fluorescence microscopy techniques. Suspensions of microscale objects or cells may be loaded separately or in gradients through the channels, allowing versatile experimental conditions. Precise and dynamic control over fluid flow fields is achieved by connecting each of the six channels to independently controlled microfluidic pumps or multi-channel microfluidic pressure regulators operated via customized computer software.

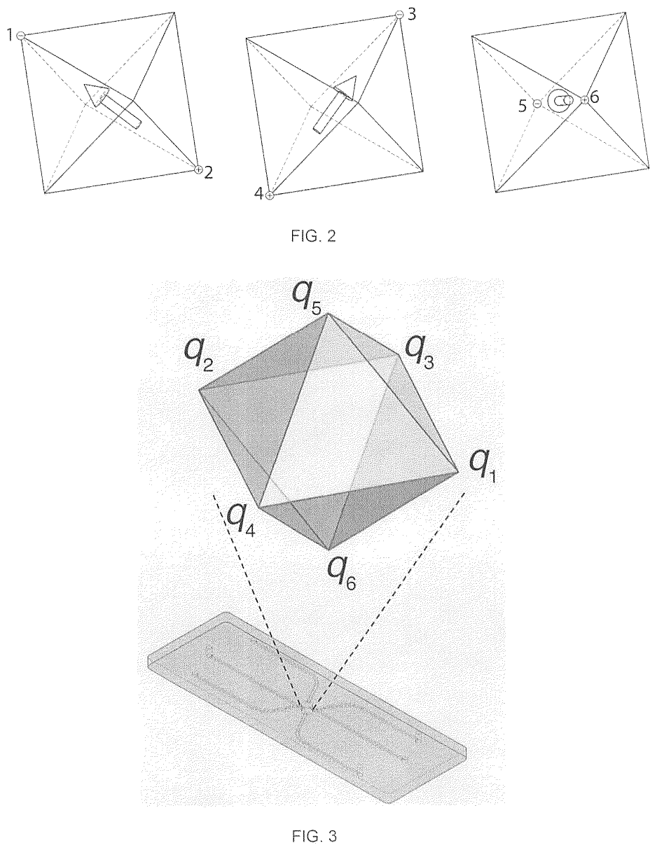

With reference to FIG. 2, uniform flow fields along three orthogonal directions are generated by leveraging the inherent octahedral symmetry of the microfluidic system 10. Specifically, three elements of the Cyclic-3 (C3) subgroup, itself a subgroup of the octahedral symmetry group, are utilized to establish these uniform fluid flow fields. The implementation of such symmetry differentiates these stress-free flow fields distinctly from stressful fields associated with traditional trapping mechanisms, thereby ensuring that microscale particles experience minimal perturbation during manipulation.

FIG. 3 further illustrates how the octahedral symmetry is practically realized within the octahedral microfluidic system 10 depicted in FIG. 1. Octahedral symmetry is achieved by selectively activating the six independently controlled channels (11a, 11b, 11c, 13a, 13b, and 13c) corresponding to apexes q1, q2, q3, q4, q5, and q6. The channels function either as fluid sources or sinks, e.g., fluid either flows into or out of the channels. By dynamically regulating the pressures via computer-controlled microfluidic pumps or multi-channel pressure controllers, the system 10 generates uniform displacement flows. The configuration permits microscale particles to move accurately along user-defined, three-dimensional trajectories without experiencing significant perturbations. The symmetrical design ensures consistency and reproducibility in particle manipulation and allows observation of manipulated objects from either the top or bottom. The compact design of the microfluidic chip 12 ensures compatibility with standard microscopy setups, supporting diverse applications in microscopy-based studies.

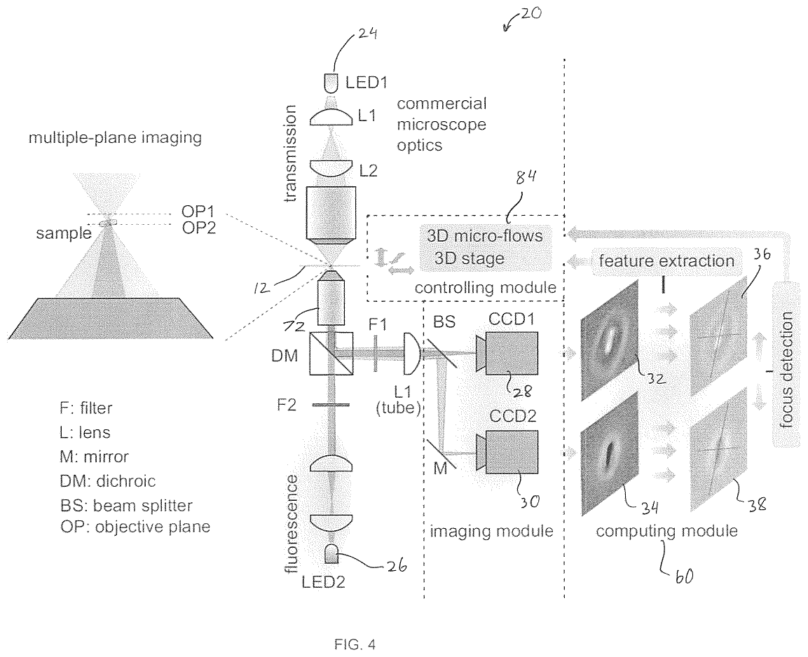

With reference to FIG. 4, an example imaging system 20 that can be integrated into the octahedral microfluidic system 10 includes microscope optics 22, illumination sources such as LEDs 24 and 26, multiple lenses (L1, L2, and L1 tube lens), filters (F1, F2), a dichroic mirror (DM), beam splitter (BS), and mirrors (M). LED 24 may be a white light source and LED 26 may be an infrared or near infrared light source suitable for fluorescence imaging. The imaging system 20 further includes two or more CCD or CMOS cameras (28, 30) positioned to simultaneously image the sample at slightly different focal planes, enabling three-dimensional tracking of microscale particles. Calibration procedures involve measuring particle contrast as the axial position (z-axis) changes. Image offset calibration is conducted by aligning views from the multiple cameras using dynamic grid adjustments (shift, rotation, scaling). Consequently, particle defocus captured by one camera is compensated by simultaneous analysis of focused or defocused views from the other camera(s), facilitating precise three-dimensional particle tracking without being limited to a monotonic contrast range. A computing device 60 extracts features 36 and 38 from captured images 32 and 34, respectively, performs focus detection, and implements feedback control to regulate the microfluidic flows, ensuring accurate and stable particle positioning and manipulation within the octahedral microfluidic system 10.

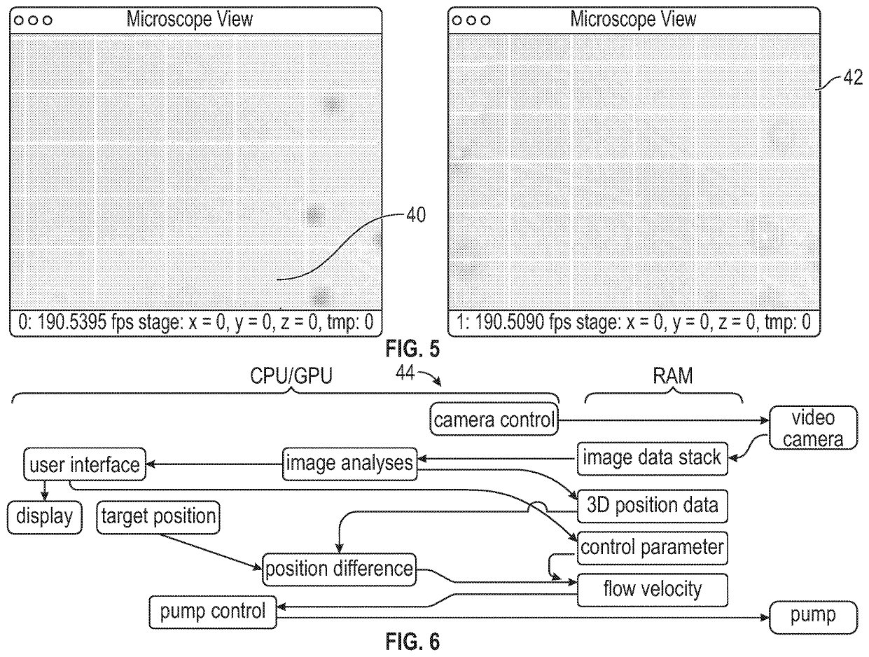

With reference to FIG. 5, example screenshots 40 and 42 from camera 28 and camera 30 illustrate the image alignment process employed within the imaging system 20. Screenshots 40 and 42 represent aligned views at slightly different focal planes, highlighting a particle that is defocused in one screenshot yet more clearly focused in the other. This alignment and the simultaneous acquisition of multiple focal-plane images facilitate accurate determination of the axial position (z-axis) of particles within the microfluidic system 10. The feature-extracted images derived from these screenshots are subsequently processed by the computing device 60 to implement precise feedback control and micromanipulation of the particles in three-dimensional space.

With reference to FIG. 6, a computing algorithm 44 implemented within a computing device includes multiple computing components, including a multicore Central Processing Unit (CPU) and a Graphic Processing Unit (GPU), which efficiently handle multitasking. Each computing task is executed as a separate thread, with inter-thread data exchange occurring through allocated Random Access Memory (RAM). Specifically, an imaging capture thread continuously acquires real-time images from the video cameras 28 and 30, storing these images into a shared image data stack. Another thread retrieves these images to perform image analyses, extracting three-dimensional particle position data and saving it into another RAM data stack. A position analysis thread compares the extracted particle positions with predetermined target positions to determine positional differences. A control parameter thread utilizes these positional differences to calculate the required flow velocities, subsequently informing a pump control thread to adjust pressures in the microfluidic pumps accordingly. Additionally, a user interface thread provides a display interface for real-time visualization of the particle positions and permits user input to adjust manipulation parameters, ensuring precise, responsive, and stress-free manipulation of microscale particles within the system 10.

In operation, a microscale particle can be precisely maneuvered along a desired trajectory by controlling fluid flows through the fluidic pumps connected to the octahedral microfluidic system 10. For example, consider a particle initially positioned at or near the center of the chamber 16 (as shown in FIG. 1). To cause this particle to travel along a predefined trajectory, such as a circular path within the focal plane, fluidic pumps connected to each of the six microfluidic channels 11a, 11b, 11c, 13a, 13b, and 13c are precisely controlled through a computing device employing a custom control algorithm as detailed in FIG. 6.

Initially, the computing device selects and activates a specific combination of fluidic pumps to produce a uniform fluid flow field along a first desired direction, causing the particle to begin motion along that axis. Subsequently, in real-time, the computer-controlled pumps adjust the pressures at each microfluidic channel according to calculated combinations of the flow modes (dipole-like fields) associated with the octahedral symmetry. By continuously and sequentially altering the relative pressure magnitudes in a controlled manner, the flow direction and velocity within the chamber 16 change smoothly, guiding the particle along the desired trajectory.

For instance, a continuous adjustment of pressures that cyclically activates pairs of opposing channels can smoothly rotate the direction of the uniform flow field, enabling the particle to follow a controlled circular path. More complex three-dimensional trajectories can be implemented by additionally modulating the relative pressures to include vertical displacement components. Because the flow fields remain stress-free and uniform, the manipulated particle experiences minimal perturbation, enabling precise and stable positioning throughout the movement along any arbitrary path defined by the flow control software.

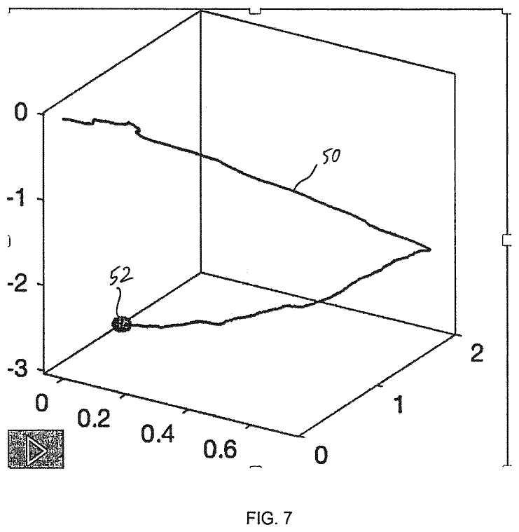

With reference to FIG. 7, an exemplary trajectory 50 of a microscale particle 52 moving freely relative to the surrounding fluid but held in place relative to the microscope by the octahedral microfluidic system 10 is illustrated, demonstrating the precise three-dimensional control achievable through the described symmetry-based method. In this representation, the particle's free movement (trajectory shown as a blue trace) from an initial position (indicated by the red dot) is measured and reconstructed by the uniform velocity that cancel its movement relative to the microscope's view, facilitated by real-time adjustments of pressures within the independently controlled channels. Importantly, due to the stress-free and uniform nature of the flow fields, sensitive particles such as biological cells can be transported accurately without experiencing disruptive perturbations. Moreover, the system can also maintain microscale particles or swimming microorganisms at fixed spatial locations—effectively “trapping” them—by continuously adjusting the uniform flow velocity to precisely counteract the object's intrinsic motion, thus creating a virtual, stress-free stationary condition relative to the laboratory frame. This capability highlights the versatility of the octahedral microfluidic system 10, enabling both dynamic displacement and stationary trapping of microscale objects without the use of conventional stressful trapping methods.

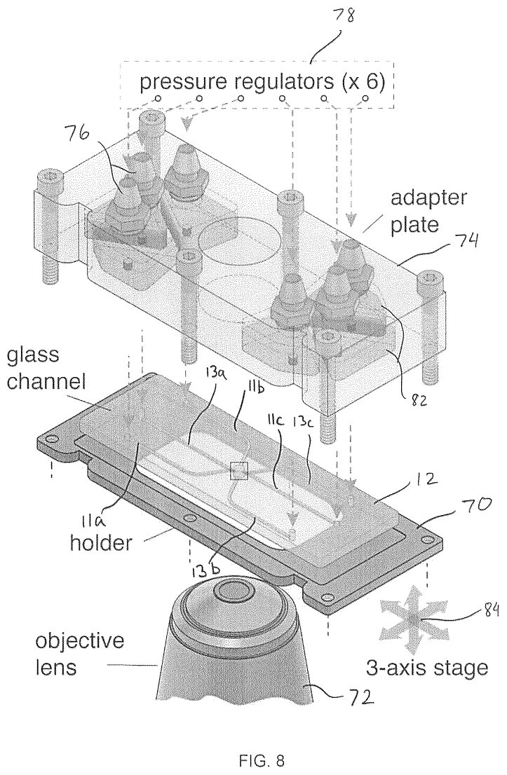

With reference to FIG. 8, a disassembled configuration of the octahedral microfluidic system 10 is illustrated, and is structurally similar to the embodiment described with respect to FIG. 1. As shown in FIG. 1, the system 10 includes the multilayer microfluidic chip 12 defining the central cylindrical chamber 16 and the six microfluidic channels 11a, 11b, 11c, 13a, 13b, and 13c arranged in an octahedral configuration about the central cylindrical chamber 16.

In the embodiment of FIG. 8, the microfluidic chip 12 is mounted within a holder 70 that provides mechanical stability and alignment relative to a microscope objective lens 72 positioned below the chip 12. The holder 70 may define an opening aligned with the central cylindrical chamber 16 to permit optical access through the clear material of the microfluidic chip 12. The objective lens 72 is positioned along an optical axis beneath the central cylindrical chamber 16, enabling bright-field, fluorescence, or other imaging modalities as previously described with respect to the imaging system 20.

An adapter plate 74 is positioned above the microfluidic chip 12 and is mechanically coupled to the holder 70 using fasteners, such as screws extending through aligned apertures. The adapter plate 74 serves as a mounting interface for fluidic components and provides structural support for pressure connectors 76. In the illustrated embodiment, six pressure connectors 76 are arranged above respective fluidic ports corresponding to the microfluidic channels 11a, 11b, 11c, 13a, 13b, and 13c. Each pressure connector 76 is configured to couple an external pressure source, such as a pressure regulator or microfluidic pump, to a corresponding microfluidic channel of the microfluidic chip 12.

The pressure connectors 76 may be fluidically connected to pressure regulators 78, which may be independently controllable and configured to introduce or withdraw fluid through the associated microfluidic channels. In certain embodiments, the pressure regulators 78 may be implemented as electronically controlled pressure controllers capable of rapid modulation of pressure magnitude. Tubes 80 may extend between the pressure regulators 78 and the pressure connectors 76 to provide fluid communication as shown in FIG. 1. The dashed arrows illustrated in FIG. 8 schematically represent independently controllable flow directions through each of the six channels, consistent with the octahedral symmetry described with respect to FIGS. 2 and 3.

The adapter plate 74 may further include reservoirs 82, each of which is fluidically coupled to a respective one of the microfluidic channels 11a-13c. The reservoirs 82 may serve as intermediate fluid volumes between the pressure connectors 76 and the microfluidic channels 11a-13c, thereby promoting stable pressure transmission and reducing transient fluctuations. In some embodiments, the reservoirs 82 may be defined by cavities formed in an upper portion of the microfluidic chip 12 and sealed by the adapter plate 74.

As illustrated in FIG. 8, the entire assembly comprising the microfluidic chip 12, adapter plate 74, pressure connectors 76, and holder 70 is positioned relative to a three-axis stage 84. The three-axis stage 84 may provide controlled translational motion of the microfluidic chip 12 along orthogonal x, y, and z directions (FIG. 4). In certain embodiments, the three-axis stage 84 may be configured as a high-speed piezoelectric or motorized microscope stage, thereby enabling rapid positional adjustments of the microfluidic chip 12 relative to the objective lens 72. Such integration permits coordinated mechanical and hydrodynamic control, which may be beneficial in embodiments employing stage-based buffering or high-bandwidth feedback control.

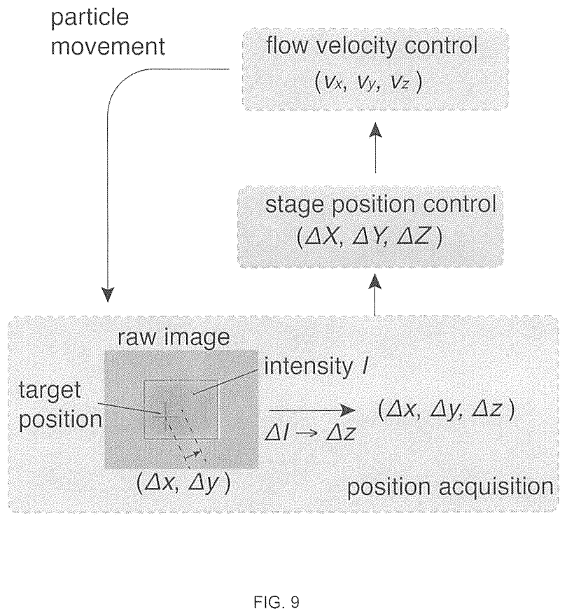

With reference to FIG. 9, a control architecture is illustrated in which the imaging system 20 and computing device 60 cooperate to perform position acquisition and generate coordinated actuation commands for both fluid flow and stage motion within the octahedral microfluidic system 10. As previously described, the imaging system 20 captures images of a microscale object disposed within the central cylindrical chamber 16 of the microfluidic chip 12. The image data includes intensity information corresponding to the optical appearance of the microscale object, and a target position within the image field is defined corresponding to a desired location within the central cylindrical chamber 16.

The computing device 60 processes the captured image data to determine lateral displacement components (Δx, Ay) of the microscale object relative to the target position. Axial displacement (Δz) may be determined based on multi-plane imaging using cameras 28 and 30, or inferred from image intensity variations and defocus characteristics. The resulting position vector (Δx, Ay, Δz) represents the deviation of the microscale object from the target position within the central cylindrical chamber 16.

Based on the acquired position information, the computing device 60 generates coordinated control outputs corresponding to flow velocity control (Vx, Vy, Vz) and, in certain embodiments, stage position control (AX, AY, AZ). The flow velocity control corresponds to a commanded substantially uniform flow field within the central cylindrical chamber 16, generated by independently regulating fluid flow through each respective microfluidic channel 11a, 11b, 11c, 13a, 13b, and 13c via corresponding fluidic ports.

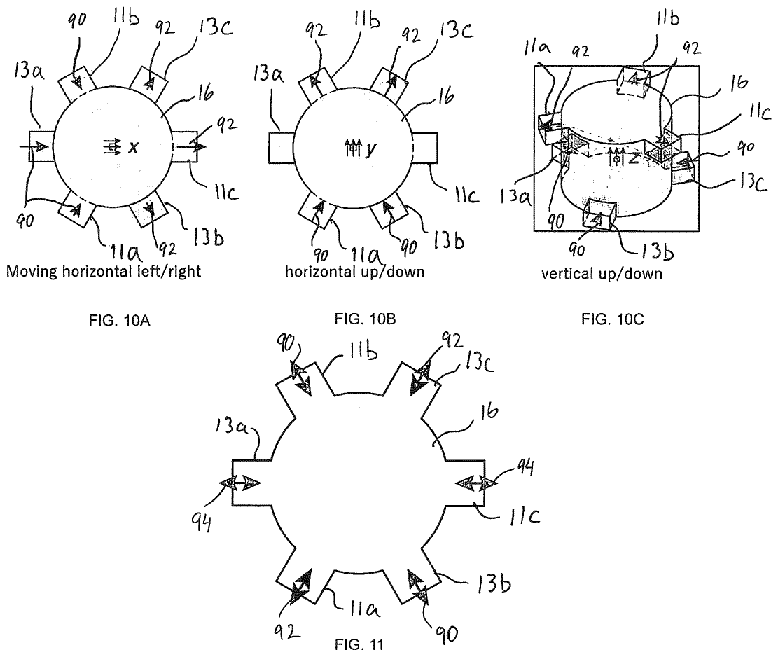

FIGS. 10A-10C illustrate representative steady-state flow modes that may be selectively established by the computing device 60 through appropriate pressure-control settings. In each figure, arrows 90 represent flow introduced through selected microfluidic channels, and arrows 92 represent flow withdrawn through opposing microfluidic channels, such that a substantially uniform displacement field is produced across the central cylindrical chamber 16.

With reference to FIG. 10A, a horizontal left/right manipulation mode is illustrated. In this configuration, a first subset of microfluidic channels, e.g., channels 11a, 11b, 13a, is actuated to introduce fluid in a first horizontal direction, as indicated by arrows 90, while an opposing subset of microfluidic channels, e.g., channels 11c, 13b, 13c, is actuated to withdraw fluid in the opposite horizontal direction, as indicated by arrows 92. The coordinated pressure-control setting generates a substantially uniform flow field across the central cylindrical chamber 16 in a first lateral direction corresponding to the x-axis. This steady-state flow mode may be used to compensate for a measured displacement component Δx or to translate a microscale object laterally within the focal plane.

With reference to FIG. 10B, a horizontal up/down manipulation mode within the focal plane is illustrated. In this configuration, selected microfluidic channels, e.g., channels 11a and 13b, are actuated such that fluid is introduced and withdrawn through opposing channels, e.g., channels 11b and 13c, in opposing directions corresponding to a second lateral axis. The resulting substantially uniform flow field is oriented along the y-axis and may be used to compensate for a measured displacement component Δy or to guide the microscale object along a second horizontal direction within the central cylindrical chamber 16.

With reference to FIG. 10C, a vertical up/down manipulation mode is illustrated. In this configuration, microfluidic channels arranged at different vertical levels relative to the central cylindrical chamber 16 are actuated such that fluid is introduced through one vertical subset of channels, e.g., channels 13a-13c, and withdrawn through an opposing vertical subset of channels, e.g., channels 11a-c. Arrows 90 and 92 represent opposing vertical flow directions. The coordinated pressure-control setting generates a substantially uniform flow field along the axial direction of the central cylindrical chamber 16, corresponding to the z-axis. This steady-state mode may be used to compensate for a measured displacement component Δz or to position the microscale object along the optical axis.

The steady-state flow modes illustrated in FIGS. 10A-10C represent elemental manipulation functions corresponding to individual velocity components (Vx, Vy, Vz). The computing device 60 may selectively activate one of these modes or combine multiple modes by superimposing corresponding pressure-control settings across the microfluidic channels 11a-11c, 13a-13c. Through such combination, arbitrary three-dimensional uniform flow vectors may be generated within the central cylindrical chamber 16. The feedback loop described with respect to FIG. 9 continuously updates the magnitude and direction of these flow components based on updated positional measurements, thereby maintaining the microscale object at the target position or guiding the object along a predefined trajectory while preserving substantially uniform, stress-free flow conditions within the octahedral microfluidic system 10.

With reference to FIG. 11, the computing device 60 is configured to generate time-dependent control signals for the plurality of microfluidic channels 11a, 11b, 11c, 13a, 13b, and 13c, such that the pressure at each corresponding fluidic port varies as a function of time. The applied pressures may follow sinusoidal or other periodic functions of time, such that each channel is driven with a defined amplitude, frequency, and phase offset. By selecting relative phase differences among the channels, non-steady flow patterns, including rotational or vortex-like manipulation modes, may be generated within the central cylindrical chamber 16. In one representative embodiment, the pressure applied to each channel may be expressed using Formula (I):

$$p i = A i cos ( ω t + i δ ) + B i \qquad ( I )$$

In Formula (I) i=1, 2, 3, 4, 5, 6, Ai represents an amplitude term, @ represents an angular frequency, di represents a phase offset associated with a respective microfluidic channel, and Bi represents a baseline pressure component. More generally, the pressures may be arbitrary functions of time pi(t), including periodic, pulsed, or other modulated waveforms.

FIG. 11 schematically illustrates the relative actuation of the six channels 11c, 13b, 11a, 13a, 11b, and 13c arranged around the central cylindrical chamber 16. Arrows 94 represent a first set of channel actuation directions corresponding to one phase grouping. In the illustrated configuration, channels 13a and 11c are driven in phase with one another, as indicated by arrows 94 positioned on opposing lateral sides of the central cylindrical chamber 16. Channels 11a and 13c form a second phase grouping, and channels 13b and 11b form a third phase grouping.

More specifically, channels 11a and 13c are driven with a common phase relationship relative to each other, channels 13b and 11b are driven with a common phase relationship relative to each other, and channels 13a and 11c are driven with a common phase relationship relative to each other. The relative phase offsets di between these three channel pairs may be selected to produce constructive and destructive interference of flow contributions within the central cylindrical chamber 16.

Unlike the steady-state uniform flow modes illustrated in FIGS. 10A-10C, in which opposing channels are actuated to produce a constant displacement field along a single axis, the oscillatory pressure-control mode of FIG. 11 permits dynamic modulation of the flow field over time. By introducing controlled phase differences among the channel pairs, the resulting flow vectors within the central cylindrical chamber 16 may rotate, oscillate, or otherwise vary temporally.

For example, if the phase offsets between successive channel pairs are selected to differ by approximately 120 degrees, the combination of time-varying flows from channels 11a, 13c, 13b, 11b, 13a, and 11c may produce a rotating flow component at or near the center of the central cylindrical chamber 16. Such a rotating flow field may impart controlled rotational motion to a microscale object without requiring physical contact or localized trapping forces. In other embodiments, alternative phase relationships may be selected to generate oscillatory shear-free translation, periodic modulation of velocity magnitude, or other time-dependent manipulation functions.

The oscillatory pressure-control mode illustrated in FIG. 11 may be coordinated with the feedback architecture described with respect to FIG. 9. The computing device 60 may determine positional information (Δx, Ay, Δz) from the imaging system 20 and superimpose a time-varying pressure component onto a steady-state uniform flow component. In this manner, the system 10 may simultaneously maintain positional control of a microscale object while introducing controlled rotational or oscillatory motion.

Accordingly, FIG. 11 demonstrates that each microfluidic channel 11a-11c, 13a-13c may be independently driven with a defined amplitude and phase, enabling generation of time-dependent symmetric flow modes within the central cylindrical chamber 16. This capability expands the manipulation functions of the octahedral microfluidic system 10 beyond steady displacement to include dynamic and rotational control while maintaining substantially uniform and minimally perturbative flow characteristics.

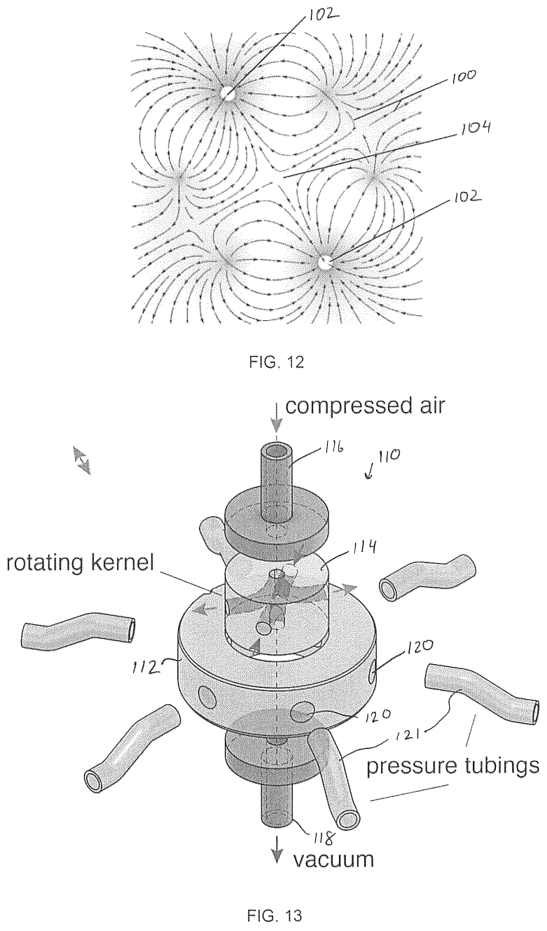

With reference to FIG. 12, the oscillatory pressure-control mode described with respect to FIG. 11 may be configured to generate oscillating quadrupole flow structures 100 within the central cylindrical chamber 16. By selecting appropriate amplitudes Ai and phase offsets di for the time-dependent pressures applied to the microfluidic channels 11a-13c, the combination of the resulting flow contributions may produce spatially periodic regions of converging and diverging streamlines. In such embodiments, the resulting flow field may form a quadrupolar structure characterized by alternating rotational regions 102 arranged about the central cylindrical chamber 16.

FIG. 12 schematically illustrates an example flow topology in which multiple vortex regions 102 are generated and spatially organized through controlled phase relationships among the channels 11a, 11b, 11c, 13a, 13b, and 13c. The streamlines depicted in FIG. 12 represent a time-dependent composite flow field resulting from oscillatory pressure inputs pi(t) applied to the respective fluidic ports. By adjusting the relative phase offsets di, the orientation of the quadrupole axes may be rotated. By adjusting the amplitudes Ai and baseline pressures Bi, the strength and spatial extent of the vortex regions 102 may be tuned.

In certain embodiments, the oscillatory quadrupole structure 100 may be used to generate and control a vortex 104 at or near the center of the central cylindrical chamber 16. The rotational speed of the vortex 104 may be controlled by adjusting the angular frequency @ of the applied pressure oscillations. The vortex strength may be modulated by adjusting the amplitude parameters Ai. The geometric characteristics of the flow field, including vortex size, symmetry, and spatial orientation, may be controlled through coordinated selection of phase offsets di among channel pairs, including the pairings previously described with respect to FIG. 11.

Unlike inertia-based or boundary-induced vortices in conventional microfluidic chambers, the vortex structures generated in FIG. 12 arise from symmetry-controlled combination of independently regulated channel flows within the octahedral configuration of the microfluidic chip 12. Because the underlying actuation remains distributed across the plurality of microfluidic channels 11a-11c, 13a-13c, the resulting flow structures may be dynamically reconfigured in real time by the computing device 60.

Accordingly, the oscillatory pressure-control architecture permits generation of time-dependent quadrupole fields 100 and controllable vortex structures 104, enabling manipulation functions including controlled object rotation, orientation adjustment, and modulation of rotational speed within the central cylindrical chamber 16 while preserving compatibility with the stress-free displacement modes described with respect to FIGS. 9-10C.

With reference to FIG. 13, a rotation-based pressure controller 110 is illustrated, which may be used with microfluidic chip 12 to control the fluid flow and pressure instead of the pressure regulators 78. In particular, the rotation-based pressure controller 110 is configured to generate time-varying pressure signals for delivery to the plurality of microfluidic channels 11a, 11b, 11c, 13a, 13b, and 13c of the microfluidic chip 12.

The rotation-based pressure controller 110 includes a housing 112 defining an internal cavity and a rotating kernel 114 disposed within the housing 112. The rotating kernel 114 is configured to rotate about a central axis. A compressed air inlet 116 is provided in fluid communication with a pressurized fluid source, and a vacuum outlet 118 is provided in fluid communication with a vacuum source. A plurality of pressure ports 120 are arranged circumferentially about the housing 112 and are configured to couple to corresponding pressure tubes 121 leading to the respective microfluidic channels 11a-13c of the microfluidic chip 12.

The rotating kernel 114 includes internal fluid passages configured such that, as the rotating kernel 114 rotates relative to the housing 112, each pressure port 120 is selectively placed in fluid communication with either the compressed air inlet 116 or the vacuum outlet 118. In this manner, the pressure delivered to each pressure port 120 varies periodically as a function of the angular position of the rotating kernel 114.

The angular velocity of the rotating kernel 114 determines the temporal frequency of pressure modulation applied to the pressure ports 120. The angular spacing between the pressure ports 120 establishes relative phase offsets between the pressure signals delivered to the respective microfluidic channels 11a-13c. The geometric configuration of the internal passages of the rotating kernel 114 determines the duration over which a given pressure port 120 is in communication with compressed air or vacuum during each rotation, thereby defining a pulse width or duty cycle. Baseline pressure levels may be adjusted by regulating the supply pressures at the compressed air inlet 116 and the vacuum outlet 118.

Accordingly, the rotation-based pressure controller 110 may generate pressure signals pi(t) at each pressure port 120, where the temporal characteristics of pi(t) are determined by rotation speed, port spacing, and kernel geometry. These time-varying pressures may be delivered through pressure tubes to the corresponding fluidic ports of the microfluidic chip 12, thereby implementing the oscillatory pressure-control modes described with respect to FIG. 11 and enabling generation of oscillating quadrupole flow structures 100 and vortex regions 102 as described with respect to FIG. 12.

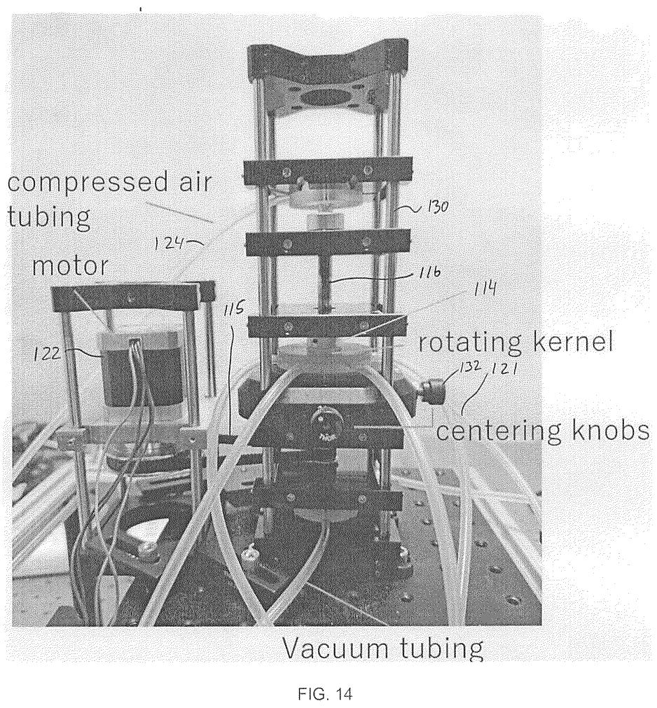

With reference to FIG. 14, an example physical implementation of the rotation-based pressure controller 110 is illustrated. In the embodiment shown, a motor 122 is operatively coupled to the rotating kernel 114 to drive rotational motion about the central axis using a belt drive 115. Compressed air tubing 124 is coupled to the compressed air inlet 116, and vacuum tubing 126 is coupled to the vacuum outlet 118. A plurality of output pressure tubes 121 extend from circumferential pressure ports corresponding to pressure ports 120 and are configured to connect to the microfluidic channels 11a-13c of the microfluidic chip 12.

The assembly may further include structural supports 130 and centering knobs 132 configured to maintain alignment of the rotating kernel 114 within the housing 112 and to facilitate adjustment and stabilization of the rotating components. The motor 122 may be configured for adjustable rotational speed control, thereby permitting dynamic tuning of pressure oscillation frequency.

The rotation-based pressure controller 110 provides a mechanical approach to multi-port pressure modulation, enabling high-frequency switching and controlled phase relationships between channels without reliance on independent high-speed electronic valves. By mechanically coordinating pressure and vacuum communication across multiple circumferential ports, the controller 110 facilitates generation of synchronized, phase-controlled pressure signals suitable for implementing time-dependent flow modes within the octahedral microfluidic system 10.

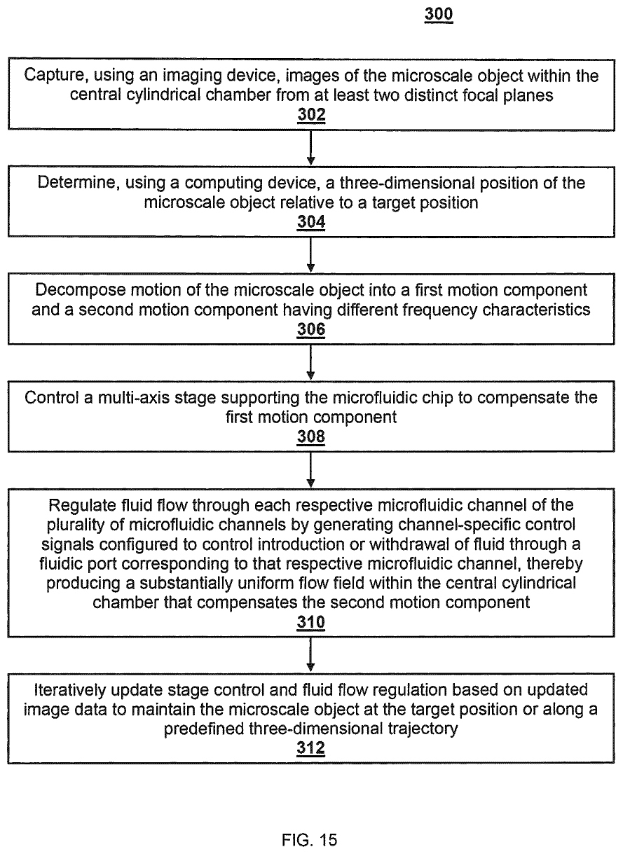

With reference to FIG. 15, a method 300 of manipulating a microscale object within the central cylindrical chamber 16 of the microfluidic chip 12 is illustrated. The method 300 may be implemented using the imaging system 20, the computing device 60, the plurality of microfluidic channels 11a, 11b, 11c, 13a, 13b, and 13c, and, in certain embodiments, the stage 84 supporting the microfluidic chip 12.

At step 302, images of the microscale object disposed within the central cylindrical chamber 16 are captured using the imaging system 20. In certain embodiments, the imaging system 20 captures images from at least two distinct focal planes, such as via cameras 28 and 30, enabling three-dimensional position determination.

At step 304, the computing device 60 determines a three-dimensional position of the microscale object relative to a target position. Lateral displacement components (Δx, Ay) may be extracted from image analysis of object position within the focal plane, and axial displacement (Δz) may be determined based on multi-plane imaging, defocus characteristics, or intensity-based analysis as previously described. The resulting position vector represents deviation of the microscale object from the target position within the central cylindrical chamber 16.

At step 306, motion of the microscale object may be decomposed into a first motion component and a second motion component having different temporal characteristics. In certain embodiments, the first motion component may correspond to rapid positional fluctuations, and the second motion component may correspond to slower drift or lower-frequency motion. This decomposition may be implemented algorithmically within the computing device 60.

At step 308, a multi-axis stage 84 supporting the microfluidic chip 12 may be controlled to compensate the first motion component. The stage 84 may be actuated along orthogonal axes to translate the microfluidic chip 12 relative to the objective lens 72, thereby reducing rapid displacement of the microscale object within the imaging field.

At step 310, fluid flow through each respective microfluidic channel of the plurality of microfluidic channels 11a-13c is regulated by generating channel-specific control signals configured to control introduction or withdrawal of fluid through a fluidic port corresponding to that respective microfluidic channel. Through coordinated actuation of the channels arranged at positions corresponding to vertices of an octahedron, a substantially uniform flow field is generated within the central cylindrical chamber 16. The generated flow field compensates the second motion component of the microscale object.

At step 312, stage control and fluid flow regulation are iteratively updated based on updated image data captured by the imaging system 20. The feedback loop may operate continuously or at discrete time intervals. Through this coordinated control, the microscale object may be maintained at the target position or guided along a predefined three-dimensional trajectory within the central cylindrical chamber 16.

The method 300 thus integrates position acquisition, optional stage-based buffering, and independent channel-specific flow regulation to achieve controlled manipulation of microscale objects within the octahedral microfluidic system 10 while preserving substantially uniform flow conditions.

The disclosed octahedral microfluidic system offers significant advantages in applications that require precise, stress-free manipulation of microscale objects, including biological cells and delicate particles. Due to the inherent symmetry of its design, the system produces uniform fluid flow fields, enabling manipulation in three-dimensional space without introducing mechanical perturbations that could affect particle integrity or viability. Consequently, the system is particularly beneficial for sensitive biological applications such as cell sorting, tissue engineering, or live-cell imaging, where even minimal mechanical stress can compromise cell viability or alter physiological behaviors.

Additionally, the system's compatibility with conventional microscopy techniques, including bright-field, phase contrast, and fluorescence imaging, broadens its applicability in biophysical and biochemical research. By integrating real-time imaging feedback and precise computer-controlled flow modulation, the system enables automated particle handling and manipulation with high spatial accuracy. Such features are especially valuable in cell biology and pharmacological studies, where maintaining stable environments or precise positional control over cells or biomolecules is often essential for reliable results.

Further, the disclosed system allows researchers to generate uniform flow fields along arbitrary three-dimensional paths, significantly facilitating experiments involving dynamic spatial gradients, cell sorting, microscale assembly, or even microfabrication processes. Because the system eliminates reliance on traditional stressful trapping mechanisms, it uniquely supports applications such as studying cell mechanotransduction, tissue engineering, or precise chemical microenvironments, thus offering researchers a versatile tool for investigating sensitive or stress-responsive microscale phenomena under highly controlled, physiologically relevant conditions.

Alternate embodiments may be devised without departing from the spirit or the scope of the present technology. Additionally, well-known elements of embodiments of the systems, apparatuses, and methods have not been described in detail or have been omitted so as not to obscure the relevant details of the systems, apparatuses, and methods.

The terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

When the terms “coupled” and “connected,” along with their derivatives, are used, these terms are not intended as synonyms for each other. For example, “connected” may be used to indicate that two or more elements are in direct physical or electrical contact with each other. “Coupled” may mean that two or more elements are in direct physical or electrical contact (e.g., directly coupled) or that two or more elements are not in direct contact with each other but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Various embodiments of the systems, apparatuses, and methods have been described, and in many of the different embodiments many features are similar. To avoid redundancy, repetitive description of these similar features may not be made in some circumstances. It shall be understood, however, that description of a first-appearing feature applies to the later described similar feature and each respective description, therefore, is to be incorporated therein without such repetition.

What is claimed is:

1. A microfluidic manipulation system comprising:
a microfluidic chip having a central cylindrical chamber and a plurality of microfluidic channels arranged around the central cylindrical chamber, wherein the plurality of microfluidic channels intersect the central cylindrical chamber at positions corresponding to vertices of an octahedron;
a plurality of fluidic ports in fluid communication with the microfluidic channels, each fluidic port configured to independently introduce or withdraw fluid from the central cylindrical chamber;
an imaging system configured to capture images of at least one particle within the central cylindrical chamber from at least two distinct focal planes; and
a computing device operatively coupled to the imaging system and configured to analyze captured images from the imaging system, determine positions of the at least one particle relative to target positions, and generate control signals for independently regulating fluid flow through each of the plurality of microfluidic channels to achieve stress-free manipulation of the at least one particle.

2. The system of claim 1, wherein the plurality of microfluidic channels comprises six channels, arranged in pairs at two distinct vertical levels around the central cylindrical chamber.

3. The system of claim 1, wherein the imaging system comprises a plurality of cameras positioned to simultaneously image the at least one particle at different focal planes for three-dimensional position tracking.

4. The system of claim 3, wherein the plurality of cameras are calibrated such that images from different focal planes provide complementary positional information based on relative particle focus or defocus.

5. The system of claim 1, wherein the computing device comprises a multicore Central Processing Unit (CPU) and a Graphics Processing Unit (GPU) configured to execute image processing, particle position analysis, flow control calculation, and user interface tasks simultaneously via separate computing threads.

6. The system of claim 1, wherein the computing device is configured to independently regulate the microfluidic channels to generate a substantially uniform flow field along a selected one of three orthogonal directions within the central cylindrical chamber.

7. The system of claim 6, wherein the computing device is configured to generate a three-dimensional flow vector within the central cylindrical chamber by additive combination of flow contributions from the plurality of microfluidic channels.

8. The system of claim 1, wherein the computing device is configured to apply time-varying control signals to the fluidic ports such that pressures applied to the plurality of microfluidic channels vary as functions of time with defined phase relationships.

9. The system of claim 8, wherein the time-varying control signals are configured to generate an oscillating quadrupole flow structure within the central cylindrical chamber.

10. The system of claim 8, wherein the defined phase relationships between the plurality of microfluidic channels are configured to generate and control a vortex within the central cylindrical chamber, including control of rotational speed and spatial orientation of the vortex.

11. A method of manipulating a microscale object within a microfluidic system, the microfluidic system including a microfluidic chip having a central cylindrical chamber and a plurality of microfluidic channels arranged around the central cylindrical chamber at positions corresponding to vertices of an octahedron, the method comprising:
capturing, using an imaging system, images of the microscale object within the central cylindrical chamber from at least two distinct focal planes;
determining, using a computing device, a three-dimensional position of the microscale object relative to a target position;
decomposing motion of the microscale object into a first motion component and a second motion component having different frequency characteristics;
controlling a multi-axis stage supporting the microfluidic chip to compensate for the first motion component;
regulating fluid flow through each respective microfluidic channel of the plurality of microfluidic channels by generating channel-specific control signals configured to control introduction or withdrawal of fluid through a fluidic port corresponding to that respective microfluidic channel, thereby producing a substantially uniform flow field within the central cylindrical chamber that compensates for the second motion component; and
iteratively updating stage control and fluid flow regulation based on updated image data to maintain the microscale object at the target position or along a predefined three-dimensional trajectory.

12. The method of claim 11, wherein regulating fluid flow comprises generating a substantially uniform flow field along a selected one of three orthogonal directions within the central cylindrical chamber.

13. The method of claim 12, further comprising generating a three-dimensional flow vector within the central cylindrical chamber by additive combination of flow contributions produced by the plurality of microfluidic channels.

14. The method of claim 11, wherein generating channel-specific control signals comprises applying time-varying control signals to the fluidic ports such that pressures applied to the plurality of microfluidic channels vary as functions of time.

15. The method of claim 14, wherein the time-varying control signals include defined phase relationships between at least two of the microfluidic channels.

16. The method of claim 15, wherein the defined phase relationships are selected to generate an oscillating quadrupole flow structure within the central cylindrical chamber.

17. The method of claim 15, wherein the defined phase relationships are selected to generate a vortex within the central cylindrical chamber.

18. The method of claim 17, further comprising controlling at least one of rotational speed, rotational direction, or spatial orientation of the vortex by adjusting at least one of amplitude, frequency, or phase of the time-varying control signals.

19. The method of claim 11, wherein determining the three-dimensional position of the microscale object comprises analyzing relative focus or defocus between images captured at the at least two distinct focal planes.

20. The method of claim 11, wherein the iteratively updating comprises continuously acquiring updated image data and dynamically modifying both stage control and fluid flow regulation in a closed-loop feedback process.
